(19) United States
(12) Patent Application Publication
(10) Pub. No.: US 2005/0253932 A1
(43) Pub. Date: Nov. 17, 2005

(54) Device and method for finding media data pertaining to suggestions

(75) Inventor: Petrus Johannes Lambertus Jacobus Van De Laar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/526,871

(22) PCT Filed: Aug. 18, 2003
(86) PCT No.: PCT/IB03/03810

§ 371 Date: Mar. 4, 2005

(30) Foreign Application Priority Data
Sep. 9, 2002 (EP) 02078656.2

(51) Int. Cl. H04N 5/225

(52) U.S. Cl. 348/207.99

(57) ABSTRACT

The invention relates to a data processing device (100) for making suggestions to a user (101), the device comprising a detector (110) arranged to detect a condition (115) pertaining to the user of said device, and presentation means (120) for presenting to the user a suggestion to perform an activity in response to the detection of said condition. The device further comprises search means (140) arranged to automatically find media data (141) which provide the user with directions for performing said suggested user activity (131), wherein said presentation means is arranged to present said found media data to the user. The found media data, when presented to the user, elucidate how the user can realize the suggestion. For instance, the device may show to the user a video clip demonstrating how suggested physical exercises may be performed. The invention also relates to a method of making suggestions to the user.

The invention relates to a data processing device for making suggestions to a user, the device comprising a detector arranged to detect a condition pertaining to the user of said device, and presentation means for presenting to the user a suggestion to perform an activity in response to the detection of said condition.

The invention also relates to a method of making suggestions to a user, the method comprising a step of detecting a condition pertaining to the user and a step of presenting to the user a suggestion to perform an activity in response to the detection of said condition.

Document WO90/15502 discloses a system comprising a timer and display means for displaying messages at predetermined intervals. Reminder messages such as reminding a viewer to run an errand, reminding an older viewer to take some medicine, or reminding a viewer of an appointment are extracted from a memory. The memory stores a start time and a count time of the message which is to be displayed on a television screen. The start time and count time of the message may also be manually set by the user. The message may be created on a computer keyboard and transferred to the memory.

The known system shows messages which are inputted and predetermined by the user. The user has to input text of the message or other information to be reminded about. Such a system is rather passive and requires some of the user's time, which the user often does not have. The known system can display only the information inputted by the user, which is concise in most cases. The displayed text message may not be very direct and descriptive for the user. This passiveness of the known system makes it unattractive for use.

It is an object of the invention to provide a device of the kind defined in the opening paragraph which, when used by the user, actively assists the user in conducting his activities.

This object is realized in that the device further comprises search means arranged to automatically find media data which provide the user with directions for performing said suggested user's activity, wherein said presentation means is arranged to present said found media data to the user.

The detector may be arranged to detect different conditions and situations such as a scheduled event in a user's agenda, a current user activity, e.g. the user watches the TV, listens to the radio, reads a newspaper or book, has breakfast etc. Upon detecting one or more of said conditions, the device provides the suggestion the user to perform the suggested activity. For example, the device may suggest that the user changes the current activity of watching TV to another suggested activity of doing physical exercise because the user has been sitting in front of the TV too long, or it may suggest starting preparation of a meal one hour before a visit by friends, or the device may remind the user about some event. Such suggestions may be generated automatically. The search means is arranged to find and retrieve the media data. The media data are preferably retrieved automatically by the search means so that the user does not necessarily have to input or select or take part in any other way in finding and/or retrieving the media data. The device determines what media data can help the user in following the suggestion, e.g. in performing the suggested physical exercises, in preparing the suggested meal. Thus, when said media data are presented to the user, he/she is provided with an extensive description or example of how to perform said activity. A video clip about cooking some meal, a video lesson on physical training, a video clip showing a clock from 5 minutes before some event till 1 minute are examples of such media data. The device according to the present invention actively provides the user with media data, which is usually information that is well perceivable by the user. This media data may also answer possible user's questions about the suggestion.

The object of the invention is also realized by the method of the present invention, the method further comprising a step of automatically finding media data which provide the user with directions for performing said suggested user's activity, and a step of presenting said found media data to the user.

These and other aspects of the invention will be further elucidated and described with reference to the accompanying drawings, wherein:

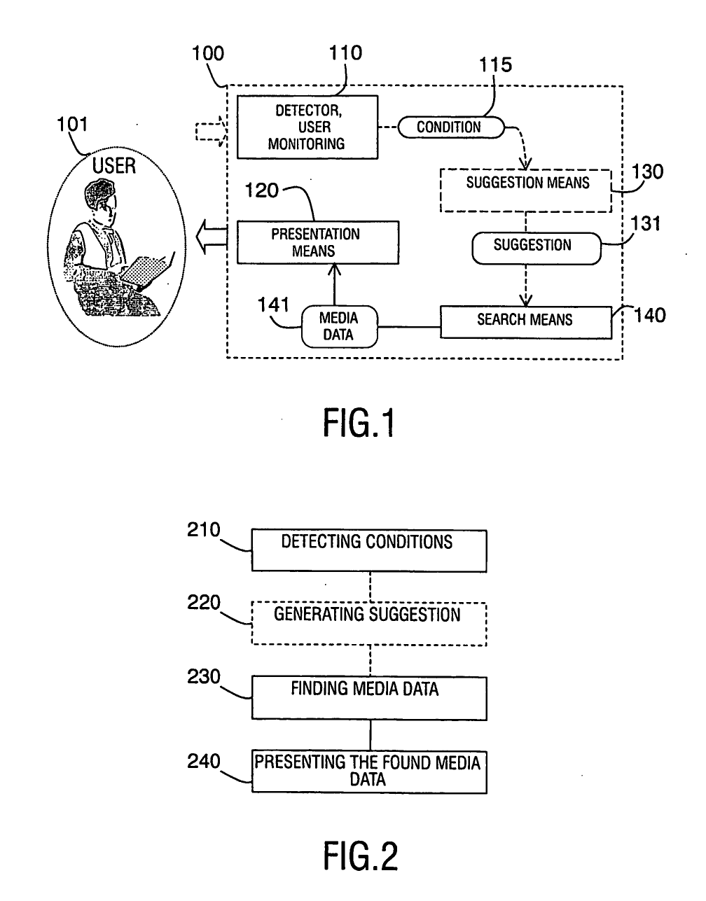

FIG. 1 shows a functional block diagram of the data processing device suitable for implementing the present invention;

FIG. 2 shows an embodiment of the method according to the present invention.

Throughout the Figures, the same reference numerals indicate identical or corresponding components.

FIG. 1 is a functional block diagram of the data processing device 100 for making suggestions to a user 101 according to the present invention. The device comprises a detector 110 arranged to detect a condition 115 pertaining to the user 101. Such a condition may be, for example, a time or date of a user's personal schedule, a user's behavior or other feature. The device may optionally comprise a storage means (not shown) for storing data the user's schedule in the device, and a timer (not shown) for counting the time in the device, wherein said timer may be coupled to the storage means and/or detector 110. The detector may be arranged to monitor the user's behavior to detect the condition. For instance, the detector may include a camera for taking pictures of the user's environment and a recognition unit arranged to recognize objects of the environment from video data recorded by the camera. The detector may also include sound input means for inputting sound from the user's environment, wherein the sound data may be inputted to the recognition unit which may be arranged to recognize a user's mood, a type of music reproduced in the environment, etc.

The conditions may be predetermined in the device and stored in the storage means, or the device may optionally comprise an analyzing unit arranged to establish the condition, e.g. by analyzing repetitive events detected by the detector 110, or by adjusting the predetermined conditions to the individual user, or the like.

The device is arranged to obtain a suggestion 131 for the user to perform an activity, and the device comprises presentation means 120 for presenting said suggestion to the user 101. The suggestions may be predetermined or generated in the device. The predetermined suggestions may be suggestions which are associated with corresponding predetermined conditions. The predetermined conditions to be detected and corresponding suggestions may be stored in the storage means. In one example, the user may schedule the device to remind the user at the predetermined time and/or date about some information, thus this time and/or date are predetermined conditions, and this reminder information is the predetermined suggestion, as known in the prior art.

The device may also comprise suggestion means 130 arranged to autonomously generate the suggestion 131 to perform the activity in response to the detection of the condition. The word “autonomously” means that the suggestion means can generate the suggestions independently of the user. For example, the suggestion means may suggest that the user follows a diet and generates diet suggestions because, for example, the user spends a lot of time passively without much physical activity and has a weight which is higher than average, though the user has never been given the diet suggestions.

The prior-art systems provide suggestions which are typically short and abstract for the user, e.g. a reminder “to prepare for the meeting”, or a suggestion “to start doing homework”. Such a suggestion does not have sufficient semantic information for details which the user may need to bear in mind with this suggestion. For instance, for a suggestion “to start doing physical exercises” the user may not know or remember what exercises he should do and/or how exactly or properly he should do them. To this end, the device according to the present invention actively participates in the process of making suggestions to the user by supplying to the user media data 141 which provide the user with directions for performing the advised user's activity 131. For example, a TV program, in which the physical exercises guiding the user to perform the suggestion are demonstrated, may be very useful for the user who is advised “to start doing physical exercises”. The user may simply and easily repeat the movements shown in this TV program, which is much better for the user than being advised with the concise suggestion, e.g. in the form of a text, like “do exercises X”. Many other benefits of the present invention may be envisaged, e.g. the user may find that the shown physical exercises are new to him/her, he may be simply pleased with surprising information, or he may learn that some suggested activity can be done in an alternative way or a better way, etc.

The device comprises search means 140 arranged to automatically find said media data 141 upon obtaining the suggestion 131. The presentation means 120 is arranged to present the found media data to the user 101. The media data may be audio data and/or video data and/or text data. The presentation means may comprise a speaker (not shown) to reproduce audio media data and/or display (not shown) video media data and/or text data. Rendering the media data may also comprise changing parameters of the user's environment, such as an ambient light. Many implementations of the search means are possible. For example, the search means may be arranged to first generate a request for the media data corresponding to a particular suggestion. Such a request may be keywords used to find the media data which can elucidate the suggestion. The request may not only comprise information about the suggestion but also about the detected condition, and generally all information which may be potentially necessary for obtaining the media data upon obtaining the particular suggestion. For instance, the request may comprise information that the user has to perform physical exercises of a moderate intensity for 10 minutes, and about the current time/date, and/or about a time when the user had his last meal, and/or what was the user's activity 1 hour before the detection of the condition occurred, etc. The request for the media data may be created by virtue of Structured Query Language (SQL) used to communicate with a database which may be stored externally or internally at the external source or at the device, respectively. It is known in the prior art that SQL statements are commonly used to perform tasks such as update data on a database, or retrieve data from a database.

Clearly, the media data to be found may not be known to the search means before the suggestion is obtained. The media data may be found in the storage means of the device 100 further arranged to store the media data. Alternatively, the device 100 may comprise communication means (not shown) capable of downloading media data from an external source via a satellite, terrestrial or cable link, or cellular phone network, link, etc., wherein the search means is coupled to the communication means for retrieving the found media data. The media data may be retrieved from the Internet using publicly accessible Internet search engines such as “Google.com”, “Altavista.com”, etc. and generally from any apparatus storing the media data and connected to the device 100 via said communication means, etc. In one example, the communication means may be a tuner/receiver arranged to receive broadcast television or other signals, and/or a modem arranged to transmit the request for the media data and/or for downloading the found media data.

The device 100 may be incorporated in an apparatus such as a television set, video cassette recorder, personal digital assistant, personal computer, portable equipment and user-wearable devices. In this way, the functions of such apparatuses can be extended with functions of the device according to the invention.

A starting time of the suggested user's activity may be selected by the user, or by the device automatically with or without the user's confirmation. The starting time may trigger the presentation means to present the found media content to the user. The suggestion means may be arranged to enable the user to manually select the starting time for performing the suggested activity. In that case, the device may comprise input means, e.g. a keyboard, pointing means, etc. arranged to provide a user's input to the suggestion means, whereas the presentation means may be arranged to facilitate the user input using the input means. Alternatively, the suggestion means may be arranged to generate a suggested starting time. For example, the suggested time may be generated on the basis of a standard time of doing the suggested activity in the detected conditions by an “archetype” of “regular user” stored in the device, or the suggested means may analyze a history of the user's behavior if it was recorded in the device. The suggested starting time may be presented to the user by the presentation means 120, and it may enable the user to confirm the presentation of the media content at the suggested starting time and/or to select another time using the input means. In turn, the suggestion means may allow the user to modify the starting time only within some period of time or impose other limits on the user-inputted modifications.

In one of the embodiments of the present invention, the presentation means may be further arranged to show, for a predetermined time before said starting time, a visual representation of a clock indicating at least said starting time. Being presented with such clock, the user may be reminded about some suggested activity in a user-friendly and unobtrusive way. The device may be arranged to show detailed information about the suggestion and/or the corresponding found media content upon a user's request. The user may realize such a suggestion information request, for example, by using the input device, e.g. a mouse or trackball input device, to click on the visual representation of the clock shown on the presentation means.

The visual representation of the clock may be standard for all suggestions. Alternatively, the detected conditions and/or the suggestions may be divided into different categories with respect to the types of user activity, such as cooking a meal, physical training, cleaning a household, etc. The visual representation may be different for the different categories of the detected conditions and/or the given suggestions.

The functions of the suggestion means, search means and other means, when appropriate, may be implemented by using a microprocessor (not shown) coupled to a random access memory and read-only memory (ROM) storing a program which, when executed by said microprocessor, can perform functions of said means as described above. The storage means may be realized with said ROM. The media data may be stored locally in the device or downloaded from the external source. The realization of such a microprocessor system with corresponding internal and external circuits will be apparent to the person skilled in the art and need not be discussed herein.

FIG. 2 shows an embodiment of the method of making suggestions to the user according to the present invention. The method comprises a step 210 of detecting the condition pertaining to the user. The method may comprise a step 220 of automatically generating said suggestion to perform said activity in response to the detection of said condition. The method further comprises a step 230 of automatically finding media data which provide the user with directions, in other words, guide the user, for performing said suggested user activity, and a step 240 of presenting to the user said found media data which pertain to the suggestion. Other embodiments of the method, which correspond to the above described embodiments of the device of the present invention, may be envisaged.

The various program products may implement the functions of the device and the method of the present invention and may be combined in several ways with the hardware or located in different other devices. Variations and modifications of the described embodiment are possible within the scope of the inventive concept. Thus, for example, the use of the verb ‘to comprise’ and its conjugations does not exclude the presence of elements or steps other than those defined in a claim. The invention can be implemented by means of hardware comprising several distinct elements, and by means of a suitably programmed computer. In the device claim enumerating several means, several of these means can be embodied by one and the same item of hardware.

A ‘computer program’ is to be understood to mean any software product stored on a computer-readable medium, such as a floppy disk, downloadable via a network, such as the Internet, or marketable in any other manner.

1. A data processing device for making suggestions to a user, the device comprising a detector arranged to detect a condition pertaining to the user of said device, and presentation means for presenting to the user a suggestion to perform an activity in response to the detection of said condition, characterized in that the device comprises
search means arranged to automatically find media data which provide the user with directions for performing said suggested user activity,
wherein said presentation means is arranged to present said found media data to the user.

2. The device of claim 1, wherein said detector is arranged to monitor user activities.

3. The device of claim 1, further comprising suggestion means arranged to autonomously generate said suggestion to perform said activity in response to the detection of said condition.

4. The device of claim 1, wherein said device is arranged to enable the user to manually select and schedule a suggestion being a reminder to perform an activity.

5. The device of claim 3, wherein said suggestion means is arranged to suggest to the user to start at least one physical exercise, said search means being arranged to find media information guiding the user to perform at least one suggested physical exercise.

6. The device of claim 3, wherein said suggestion means is arranged to suggest to the user a starting time for performing said suggested activity.

7. The device of claim 3, wherein said suggestion means is arranged to enable the user to manually select a starting time for performing said suggested activity.

8. The device of claim 6, wherein said presentation means is arranged to show, for a predetermined time before said starting time, a visual representation of a clock indicating at least said starting time.

9. The device of claim 1, wherein said search means is further arranged to obtain said media data from an external source.

10. An apparatus incorporating the device as claimed in claim 1, the apparatus being selected from a group of a television set, video cassette recorder, personal digital assistant, personal computer, portable equipment.

11. A method of making suggestions to a user, the method comprising a step of detecting a condition pertaining to the user and a step of presenting to the user a suggestion to perform an activity in response to the detection of said condition, characterized in that the method comprises:
a step of automatically finding media data which provide the user with directions for performing said suggested user activity, and
a step of presenting said found media data to the user.

12. A computer program product enabling a programmable device, when executing said computer program product, to function as the device as defined in claim 1.
